(19) United States
(12) Patent Application Publication
(10) Pub. No.: US 2010/0279537 A1
(43) Pub. Date: Nov. 4, 2010

(54) Cord and Cable Fastening System and Method

(76) Inventor: Kirk Andrade, Sebastopol, CA (US)

Correspondence Address: LOEB & LOEB, LLP, 321 NORTH CLARK, SUITE 2300, CHICAGO, IL, 60654-4746, US

(21) Appl. No.: 12/433,511

(22) Filed: Apr. 30, 2009

(51) Int. Cl. H01R 13/62

(52) U.S. Cl. 439/369; 174/135

(57) ABSTRACT

A system and method for providing cord and cable fastening (CCF) so Industrial, Commercial and Home users (ICAHUs) can assure that cords and cables, including but not limited to electrical cords, cannot be accidentally disconnected or unplugged. The system and method allows ICAHUs to work safely and efficiently and to avoid cords and cables that may accidentally disconnect or unplug themselves in the course of everyday use. ICAHUs can easily apply collar mechanisms to the end of cords or cables aft of said cord's respective plug ends or cables ends, and then subsequently attach said collar mechanisms together using a series of collar ties that are adjustable in length and tension, and tie connectors which facilitate said adjustment of said collar ties. The method comprises a system in which cords and cables, including but not limited to standard electrical cords may be fastened together then held tightly together without easily becoming accidentally unplugged. Said system and method also supports securing said cord or cable to itself, to another, or to an object to secure and store either before or after said cords and cables are used.

### FIELD OF THE INVENTION

The present invention is in the field of Industrial, Commercial and Home use, specifically a system and method to safely fasten a cord or cable, including but not limited to an electrical cord, to another cord or cable, to itself or other objects. Said cords or cables may include but shall not be limited to either a stand-alone electrical cord or an electrical cord attached to an electrical device such as a power tool or appliance. Said invention shall assure that said cords or cables remain connected in the course of normal use and do not become unplugged or disconnected from one another.

### BACKGROUND OF THE INVENTION

Today, it is necessary for Industrial, Commercial and Home users (ICAHUs) of tools and systems, including but not limited to electrical tools, electrical appliances and computer systems to work safely and efficiently. Often, cords or cables, including electrical cords, may accidentally unplug themselves or disconnect in the course of everyday use; thus, creating an inconvenience and possibly a safety hazard. To avoid said cords or cables from unplugging, ICAHUs often tape cords or cables together or take time to “wire them” or “rig them” together, tie them or just connect them together and hope they don't become accidentally disconnected. Cords and cables becoming disconnected can be hazardous, such as in the loss of power to a device, and scrambling around to connect cords or cables that become disconnected can be time consuming. For this reason and others, this present invention, a cord and cable fastening (CCF) system and method will easily accommodate and facilitate that said cords and cables used by ICAHUs stay connected during use.

ICAHUs need to work safely and efficiently. For example, an electrical device needs to remain plugged-in to be able to receive electricity to function. Time used to plug-in electrical devices that become unplugged is wasted. ICAHIUs also may need to move within a work environment in which cords or cables may become snagged or caught on objects and could become disconnected. With the CCF system and method, ICAHUs can easily fasten cords and cables together, including but not limited to, cords on electrical devices to assure they remain connected.

In addition, because of the need for ICAHUs to work safely and efficiently, companies such as Home Depot, Ace Hardware, Home Club, Sam's Club, K-Mart, Sears, Stanley, Loews, Wal-Mart and Costco, may more-than-likely desire to sell the cord and cable fastening system and method that is comprised in this invention. This can be sold as a stand alone product or in combination with cords, cables, including but not limited to electrical cords and power devices, and cords attached to power tools.

Moreover, in addition to assuring that cords and cables remain connected during use, a need also exists for a system and method to help secure the cords and cables before and after use and to attach said cords and cables to objects or even to itself. An example is the need for a typical construction worker who needs a system and method to attach lengthy and heavy extension cords or cables to his or her work truck at the end of the day and to have said cords and cables remain secure and in place. Another example is the need for a person to wrap a cord or cable after use and to securely fasten said cord or cable to a shelf or its resting place.

Heretofore, inventors have not created and developed a system and method for facilitating cord and cable fastening that will fit easily on standard cords and cables, including but not limited to standard electrical cords, and that will actually hold them securely during the stresses and demands encountered in a work environment. This invention permits said ICAHUs to employ the CCF system and method easily with many types of cords and cables, including standard, electrical cords that typically contain male and female connectors or plug ends that fasten by fitting the male connector into the female connector by using direct pressure without the need for any twisting of the connectors or their parts. This invention also allows ICAHUs to employ said CCF system to secure said cords and cables by securing said cords and cables to another, to itself or to an object including but not limited to a work vehicle, and storage place or other object.

U.S. Patent Application Publication No. 2003/0157824 (Ito, August 2003), expressly incorporated herein by reference, relates to a method for a Power Cord Connecting Set which is similar to a cord fastening system and method. This existing art is for specific type of plug set, both male and female, and is not able to be easily fastened to existing standard electrical cords without replacing the actual plug ends of said electrical cords with specialized and customized plug ends. Moreover, the existing art will not allow itself to be easily removed from one set of electrical cords and then transferred to another without either heavy modification, and the possibility of ruining the existing set of plug ends. The existing art is specifically a type of complex plug end that is not simple in nature as opposed to this present invention which is not a plug end but instead a cord and cable fastening system that will not require the modification or alteration of plug ends and that may be easily moved from cord and cable sets to others.

U.S. Patent Application Publication No. 2003/0139085 (Chia Hsien, July 2003), expressly incorporated herein by reference, relates to a method for an Electric cord connector kit which is not similar to the cord and cable fastening system and method of this present invention, in that the electrical cord connector kit is a kit used to “splice” together actual electrical cords and to join then together by crimping them, and is not designed to “connect” and “disconnect” or to hold standard cables and cords in place, for their easy and subsequent disconnecting after use. This existing art is for permanently joining together electrical cords and is quite different form this present invention in design and scope.

U.S. Pat. No. 5,044,976 (Thomson, 1991), expressly incorporated herein by reference, relates to an electrical cord holding device that possesses a hook-and-loop fastening mechanism that protrudes from, and is secured to, a cover plate, and a reciprocal second portion of a hook-and-loop fastening mechanism that is clamped onto a power cord, wherein the first and second portions of the hook-and-loop fastening mechanism assist in retaining a plug within an outlet. This existing art is specifically for connecting electrical cords into wall outlets and is entirely different in its scope and design from this present invention that is designed to securely maintain that cords and cables are connected together, with a focus on cables and cords that are standard, such as including but not limited to on electrical extension cords and electrical devices, such as is the engagement of a female plug head of an extension cord to the male plug head of a corded power tool or appliance.

U.S. Pat. No. 5,348,495 (Kasden, 1994), expressly incorporated herein by reference, relates to an “electrical cord plug lock assembly having a special electrical socket face plate with a pair of laterally spaced locking brackets extending outwardly from its front surface adjacent the opposite sides of the socket aperture.” This existing art is specifically for connecting electrical cords into wall outlets and is entirely different in its scope and design from this present invention that is designed to securely maintain that cords and cables are connected together, with a focus on cables and cords that are standard such as including but not limited to on electrical extension cords and electrical devices, such as is the engagement of a female plug head of an extension cord to the male plug head of a corded power tool or appliance.

U.S. Pat. No. 5,547,390 (Laherty, 1996), expressly incorporated herein by reference, relates to an “electrical plug securing device provides a length of material and embodies appendages into which are formed slots”. This existing art is specifically for connecting electrical cords into wall outlets and is entirely different in its scope and design from this present invention that is designed to securely maintain that cords and cables are connected together, with a focus on cables and cords that are standard such as including but not limited to on electrical extension cords and electrical devices, such as is the engagement of a female plug head of an extension cord to the male plug head of a corded power tool or appliance.

U.S. Patent Application Publication No. 2004/0166718, (Yoest, Daniel, August 2004), expressly incorporated herein by reference to a method for a power cord plug securing device is somewhat similar in purpose to the cord and cable fastening system and method of this present invention, in that it is a system and method for securing power cords together; however, the existing art by Yoest claims the use of a “clasp member” that is “substantially U-shaped” in order to attach itself to an electrical cord, and in the present invention, a collar mechanism is used that is more secure. Also, in the existing art by Yoest, said “clasp member comprises a trough region with retaining walls extending therefrom, said retaining walls terminating in inwardly projecting ends for securely maintaining the portion of the power cord immediately aft of the plug head within said through region” which is markedly different from what is claimed in this present invention, in which a collar mechanism is used. Moreover, the existing art claims a device in which “at least one of said trough region and said retaining walls are at least partially textured or ribbed for increased frictional association with the portion of the power cord retained therein” which indicates that texture and ribbing are employed to create friction as a means of attaching a clasp to a power cord and retaining said power cord; however, in this present invention, what is claimed is the attachment of a collar mechanism to connect to a cord or cable which is markedly different and uses pressure created by the use of fasteners and/or a snap-together hold to accomplish securing said collar mechanism to said cord or cable, which is expected to secure more strongly to said cord or cable than said existing art and therefore will out-perform said existing art. Moreover, existing art claims a “securing strap” which is formed out of one-piece that is also is joined by a “clasp member” on each respective end. Said “securing strap” is not adjustable and is a singular piece which posed two problems: 1) because said “securing strap” is not adjustable it may not fit on a myriad of power cords that employ different types and sizes of male or female plug ends; and 2) because said “securing strap” is a singular piece, it may be prone to failure in that it would be weakest in retaining connected cords when pressure was applied from the direct edge of the “securing strap” that was opposite from the cord, then when applied inward toward said cord. This present invention claims collar ties that are superior to “securing straps” because they are adjustable and therefore will fit a myriad of cords types and sizes. Moreover, this present invention claims the use of multiple collar ties so that they will be able to withstand the pressure that is applied to cords in a work environment, such as construction or carpentry, without having them become disconnected. Furthermore, this invention claims a collar mechanism that is markedly different from the existing arts claim of a “clasp member” that is “substantially U-shaped” employing a “trough region” in that said “clasp member” of existing art allows for said cord to be unseated and thereby removed from said “trough” of the “clasp member” when exposed to pressure, since it does not close around said cord and allows said cord to “pop-out”—thereby failing in its objective; whereby, said cord or cable will not be allowed to become either unseated or removed from said collar mechanism of the present invention when exposed to pressure since said cord or cable is fully enclosed by said collar mechanism—thereby succeeding in its original purpose and objective.

An existing product is available called the “Kord-O-Loc” that uses two “L-shaped” pieces of plastic with serrated edges that lock together in an attempt to fasten electrical cords together; however said product rests on the back of the electrical cord plug ends, does not securely attach to the cords and is easily disconnected if the cords are pulled away from each other, particularly with a small amount of force in which the cords will “pop out” of said product.

An existing product is available called the “Kord Manager Cord Lock” that uses one “S-shaped” piece of plastic in an attempt to fasten electrical cords together; however said product rests on the back of the electrical cord plug ends, does not securely attach to the cords and is easily disconnected if the cords are pulled away from each other, particularly with a small amount of force in which the cords will “pop out” of said product.

Accordingly, existing inventions describe methods and systems for assuring that electrical cords remain plugged-in or connected, but there does not appear to be an invention that possesses all the features and components of our system and method for delivering a cord and cable fastening solution as in this present invention. To summarize, the systems and methods of the existing inventions have one or more of these disadvantages:
Existing art is not easy-to-use and requires modifying plug ends of electrical cords.
Existing art requires replacing standard plug ends on cords with specialized or customized plug ends and therefore cannot be easily removed from one cord or device to another.
Existing art employs the use of “clasps” to attach to a plug that rely on friction; but that ultimately will allow cords to “pop-in” and “pop-out” of said clasp as pressure is applied, thereby failing to secure said cord if it is dragged or pulled during working conditions and an obstacle or impediment snags said cord creating pressure on “clasps”.
Existing art employs clasps that are “open” in that they do not surround the cord they attach to but allow the cord an area in which it may “pop-out” of said clasp when under pressure.
Existing art employs a singular securing strap that is not adjustable and therefore will not fit numerous types and sizes for male and female connectors and other connectors as are used on multiple cord configurations.
Existing art employs a singular securing strap that will not allow it to offset pressure paced upon cords when they are under stress during work conditions.
Existing art is not sufficiently strong enough to be used under work conditions, such as at a construction site, where tools are heavy, cords and cables are pulled tight, and fasteners that may fail can create a safety risk.
Existing art does not intelligently solve the problem or securing and fastening cords before and after the cord is used in a work setting.

### SUMMARY OF THE INVENTION

The present invention relates to a system and method enabling a cord or cable to remain connected to another cord or cable and not to become accidentally disconnected or unplugged while being used by Industrial, Commercial and Home users (ICAHUs) that may be using cords or cables, including but not limited to cords on electrical tools and appliances. Said invention allows ICAHUs to work safely and efficiently. This present invention, a cord and cable fastening (CCF) system and method will easily accommodate and facilitate that said cords and cables used by ICAHUs stay connected during use.

This present invention will be described further in preferred embodiments, and it overcomes all of the above-mentioned disadvantages of today's existing art. This invention secures cords and cables together and provides an ideal solution for securely assuring that a cord or cable remain connected to either another cord or cable, to itself or to another object. An example would be an extension cord or a device with a similar cord such as a power tool would remain connected to each other.

Broadly stated, this present invention is a cord and cable fastening system and method that in its best mode form has multiple collar pieces, or members, that can fasten together to connect to a cord or cable, multiple, or a plurality of, collar ties that are adjustable and tie connectors that can lock and unlock from each other in order to allow collar ties to adjust in order to create tension and thereby hold the cords or cables together.

The invention relates to a cord and cable securing device, comprising a plurality of collar mechanisms for connecting to and retaining a cord and cable therein; a plurality of collar ties that connect to the collar mechanisms; and a plurality of tie connectors for allowing collar ties to fasten together, thereby ensuring the connection between cords and cables. The invention also relates to a device wherein the collar mechanism further comprises a collar member designed to connect to a cord or cable by having a substantially identical collar member connect to it, thereby securing the cord or cable, wherein the cord or cable is fully enveloped and enclosed, wherein the cord or cable is secured within the collar mechanism, and wherein the collar mechanism securely connects to the portion of the cord or cable immediately aft of end of the cord or cable or any plug head attached thereto.

The invention further relates to a method of maintaining a connection between cords and cables, comprising obtaining a device having a collar mechanism for connecting to the cords and cables, the collar mechanism having a collar tie in connection with the collar mechanism; and connecting the collar tie to a tie connector; the tie connector to facilitate the adjustment of length and tension of the collar tie between the collar mechanism and the tie connector.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 is a drawing depicting the “Best Mode” Cord and Cable Fastening (CCF) System and Method of the preferred embodiment in which a multiple-piece, or member, collar mechanism is employed.

FIG. 2 is a drawing depicting a mode of the Cord and Cable Fastening (CCF) System and Method, including Cord, of the preferred embodiment.

FIG. 3 is a drawing depicting the Cord and Cable Fastening (CCF) System and Method, with a snap hold collar mechanism, of the preferred embodiment.

FIG. 4 is a drawing depicting the Rear View of a Collar Mechanism, with a snap hold, of the preferred embodiment.

### DETAILED DESCRIPTION OF THE INVENTION

In greater detail, this present invention, in its preferred form, is a cord and cable securing device having collar pieces, or members, that fasten together to connect to a cord or cable and that may be fastened together by means, including but not limited to, screws, screwing through holes in one collar and screwing into another; bolts, protruding through one collar and screwing into either the opposite collar or into a nut embedded in the opposite collar; a snap hold, in which two collar pieces, or members, are adjoined on one edge and in which the opposite edge is able to close down and thereby crimp the cord, holding it, and in which a protrusion on one edge of the collar opposite the adjoined edge is snapped over the adjoined collar onto its edge opposite the adjoined edge. The present invention may also employ collar mechanisms that snap or lock together that may not be adjoined, but may be separate pieces, or members. The collar mechanisms of this present invention are designed to fully enclose around the cord and therefore shall not allow for an area in which the cord may “pop-out” or escape the collar as is the case with existing art.

Moreover, collar ties are connected to collar pieces, or members, and may be connected by means, including but not limited to, placing a rivet, grommet or similar member in said collar tie and then sliding said collar tie into a tapered groove in said collar until said rivet, grommet or similar member seats itself in said tapered groove, thereby becoming fastened. Collar ties may be connected to collar pieces, or members, by means, including but not limited to, weaving said collar tie through spaces in said collar in which the use of tension may will cause said collar tie to hold the collar firmly enough to allow the present invention to function.

Moreover, the use of glues, epoxies or other fastening adhesives may be applied in order to secure said collar tie to said collar or also itself. Said collar ties may be made out of numerous types of material including but not limited to woven fabric, nylon, polypropylene, mesh-type material, or other similar material. Said collar ties connect to tie connectors that may use numerous configurations including but not limited to male and female buckles, any type of dual-adjust buckle or fastener, snap-together assemblies or other means.

The purpose of the tie connectors are to allow said collar ties to be adjusted and to then hold to each opposite tie connector, in order to allow adjustable tension to be created and thereby held in order to transfer and thereby keep tension on the ends of cords and cables that should remain connected to expedite a process, such as the uninterrupted flow of electricity in the case of an electrical cord.

Accordingly, a feature and advantage of this present invention is its ability to prevent accidental or forced disconnection of cords and cables, such as electrical cords. In other terms, this present invention assures that cords and cables remain connected.

Another feature and advantage of this present invention is its ability to allow the cord or cable to be attached to another, or itself or an object in order to store and secure said cord or cable. This is done by allowing said collar ties to be adjustable in length and by allowing said tie connectors to fasten to each other. For example, if a cord or cable has the present invention secured to it, said tie connectors may be wrapped around a metal bar on the back of a work vehicle and subsequently connected to one another, then said collar ties may be used in order to create tension in the collar ties and thereby secure said cord or cable to said work vehicle or other similar object.

This invention can be used to help secure the cords and cables before and after use and to attach said cords and cables to objects or even to itself. An example is the need for a typical construction worker who needs a system and method to attach lengthy and heavy extension cords or cables to his or her work truck at the end of the day and to have said cords and cables remain secure and in place. Another example is the need for a person to wrap a cord or cable after use and to securely fasten said cord or cable to a shelf or its resting place. Furthermore, the present invention can be used to secure, not only cords and cables, but hoses and other objects that can be stored in a coiled form.

Another feature and advantage of the present invention relates to the ease of manufacture of the cord and cable fastening device. Because of the design of the device, the production of the device is very simple and inexpensive. Once the collars are manufactured, they are easily coordinated with the collar ties to produce the cord and cable fastening device of the invention. Competing devices, even if relatively easy and low-cost to manufacture, still have the disadvantages in performance (e.g., failure during normal use).

The preferred embodiment of the present invention will now be described in even greater detail by reference to the following figures.

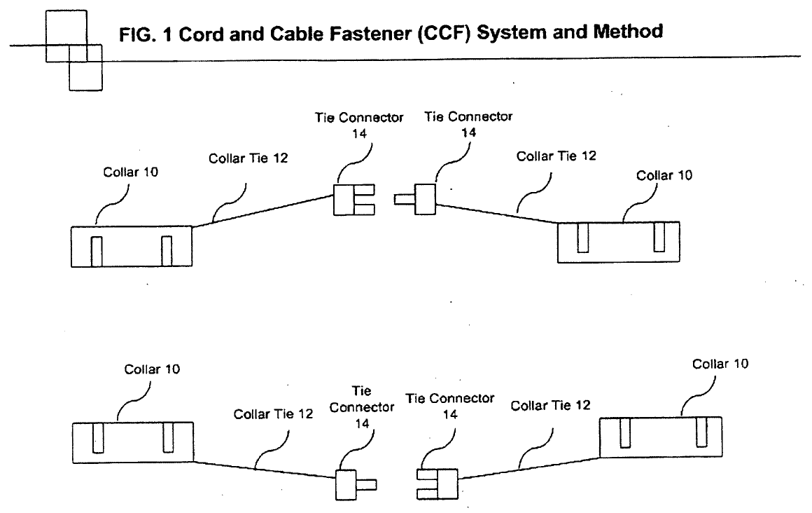

FIG. 1 depicts the overall “Best Mode” Cord and Cable Fastening (CCF) system and method of the preferred embodiment which includes a series of collars 10 that can be fastened together using a myriad of methods including but not limited to being screwed together using standard screws. Said collars 10 may also be snapped together or attached together by a plurality of means, as their function is still to connect to a cord or cable in order to hold the cord or cable and to create a place to connect to a collar tie 12, which fits between said collar 10 and also fastens to an tie connector 14 that may be designed in a fashion, including but not limited to a male into female plastic-type buckle, a snap connector, or other means. In any case, said tie connectors 14 are designed to connect to each other and said collar tie 12 is designed to be adjustable to remove slack between said collar 10 and said tie connector 14, which thereby is able to create pressure that will aid in assuring that cords and cables can remain connected to each other.

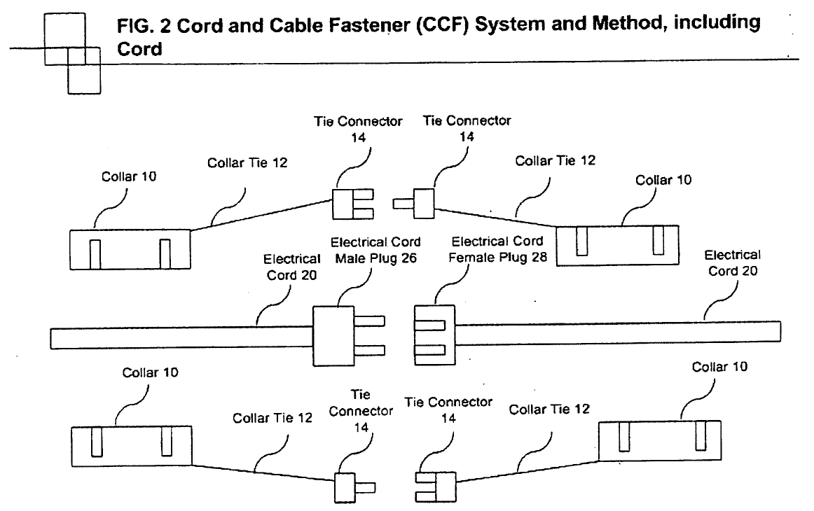

FIG. 2 depicts the overall Cord and Cable Fastening (CCF) system and method, including a cord, of the preferred embodiment which is similar to FIG. 1 and also includes a series of collars 10, collar ties 12, and tie connectors 14. Said collars 10, said collar ties 12, and said tie connectors 14 are arranged so that an electrical cord 20 can be fastened to another in a familiar way in which an electrical cord male plug 26 can be inserted into an electrical cord female plug 28, and whereby said collars 10 may fasten to said electrical cord 20, and in which said tie connectors 14 may attach to one another to then allow for adjustable collar ties 12 to be adjusted so slack in said collar ties 12 is reduced and so pressure is created to hold said electrical cord male plug 26 together with said electrical cord female plug 28, thereby not allow them to become unplugged and/or disconnected through normal use.

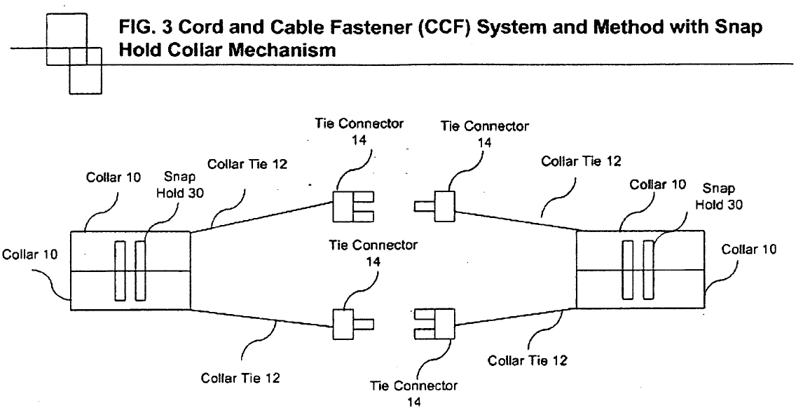

FIG. 3 depicts the Cord and Cable Fastening (CCF) system and method with a snap hold of the preferred embodiment which includes a series of collars 10 that can be fastened together using a myriad of methods including but not limited to being screwed together using standard screws. Said collars 10 may also be snapped together using snap holds 30 that are molded into said collars 10 in which one collar is adjoined to another on one edge and design to fold over in order to connect to said cord or cable, and whereby one edge opposite of the adjoined edge of said collar 10 is designed with a protrusion that will slide over an indentation in the one edge opposite of the adjoined edge of said adjoined collar 10 thereby forming a snap hold 30, thus allowing them to fasten to said cord or cable. Collars 10 may also be attached together by a plurality of means, as their function is still to connect to a cord or cable in order to hold the cord or cable and to create a place to connect to a collar tie 12, which fits between said collar 10 and also fastens to an tie connector 14 that may be designed in a fashion, including but not limited to a male into female plastic-type buckle, a snap connector, or other means. In any case, said tie connectors 14 are designed to connect to each other and said collar tie 12 is designed to be adjustable to remove slack between said collar 10 and said tie connector 14, which thereby is able to create pressure that will aid in assuring that cords and cables remain connected to each other in the course of use.

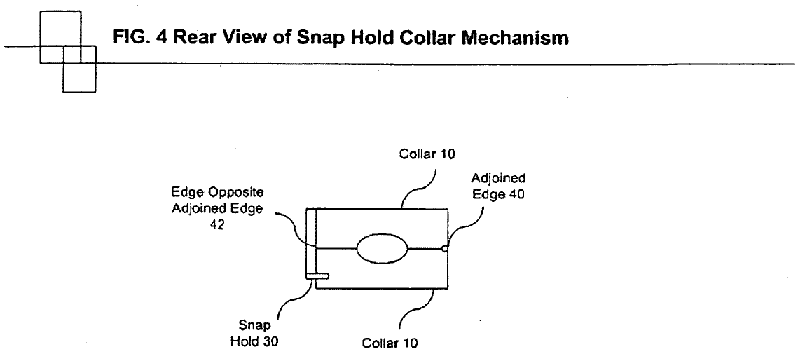

FIG. 4 depicts the Rear View of a Collar Mechanism, with a snap hold, of the preferred embodiment, which displays a series of collars 10 that can be fastened together and unfastened by snapping them and unsnapping them by the use of a snap hold 30 that is molded into said collars 10 in which one collar is adjoined to another on one edge, the adjoined edge 40, whereby a design is formed to allow said collars to fold open, remaining adjoined at the adjoined edge 40, and whereby the edge opposite the adjoined edge 42 comes apart creating and area in which a cord or cable may be inserted, before said collars 10 are moved toward each other and any distance between collars at said edge opposite adjoined edge 42 decreases and then said snap hold 30 is employed in order to connect said collar mechanism to said cord or cable, thereby connecting to it securely, allow no area in which said cord or cable can “pop-out” or escape said collar mechanism.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements, which, although not explicitly described or shown herein, embody the principles of the invention and, thus, are within its scope and spirit.

What is claimed is:

1. A cord or cable securing device, comprising:
a plurality of collar mechanisms for connecting to and retaining a cord and cable therein;
a plurality of collar ties that connect to said collar mechanisms; and
a plurality of tie connectors for allowing collar ties to fasten together, thereby ensuring the connection between cords and cables.

2. The device of claim 1, wherein said collar mechanism is adapted to removably engage and securely retain a portion of the cord or cable immediately aft of the end of said cord or cable or aft of a plug head when attached thereto.

3. The device of claim 1, wherein said collar mechanism comprises multiple members to be fastened together with means selected from the group consisting of screws, nuts and bolts, and a snap-hold connection.

4. The device of claim 1, wherein said collar mechanism further comprises:
a collar member designed to connect to a cord or cable by having a substantially identical collar member connect to it, thereby securing said cord or cable, wherein said cord or cable is fully enveloped and enclosed,
wherein said cord or cable is secured within said collar mechanism, and
wherein said collar mechanism securely connects to the portion of the cord or cable immediately aft of end of said cord or cable or any plug head attached thereto.

5. The device of claim 1, wherein said collar tie is secured to said collar mechanism.

6. The device of claim 1, wherein said collar tie is secured to said collar mechanism by means selected from the group of a rivet or grommet-style member applied to said collar tie, wherein said collar tie is slid inside of a tapered groove existing in said members of said collar mechanism, or said collar tie is secured to said collar mechanism by weaving said collar tie through a configuration in said collar mechanism, applying a glue-style substance to said collar tie, or a combination thereof.

7. The device of claim 1, wherein said tie connectors and said collar ties are adjustable in length and tension.

8. The device of claim 1, wherein said collar mechanisms, said collar ties, and said tie connectors are separate, individual members and are not a singular molded member.

9. The device of claim 1, wherein said collar mechanisms, said collar ties, and said tie connectors may be a series of individual members or a singular molded member.

10. The device of claim 1, in which said cord or cable and corresponding plug end are selected from an indoor plug wire, an outdoor plug wire, an industrial plug, an appliance plug, a telephone plug wire, a LAN plug wire, a WAN plug wire, a cable wire, a data cable, and a coaxial cable.

11. The device of claim 1, wherein said collars are adjoined on one edge or non-adjoined on one edge; snap together and unsnap from each other on the edge opposite the adjoined edge or the non-adjoined edge; in order to connect to and disconnect from a cord and cable.

12. The device of claim 1, wherein a first collar mechanism is connected to retain a portion of a cord or cable immediately aft of any plug end attached thereto, and wherein a second and identical collar mechanism is connected to retain a portion of the second cord or cable immediately aft of a plug end attached thereto.

13. The device of claim 12, wherein said first and second collar mechanisms are able to connect entirely around the outside diameter of a cord or cable, thereby securing and preventing any pressure on the cord or cable, there by preventing escape from said collar mechanisms.

14. The device of claim 12, wherein said first and second collar mechanisms each comprise multiple members that are fastened together with means selected from the group consisting of screws, nuts and bolts, and a snap-hold connection.

15. The device of claim 12, wherein said collar mechanisms further comprises
a collar member designed to connect to a cord or cable by having a substantially identical collar member connect to it, thereby securing said cord or cable, wherein said cord or cable is fully enveloped and enclosed,
wherein said cord or cable is secured within said collar mechanism, and
wherein said collar mechanism securely connects to the portion of the cord or cable immediately aft of end of said cord or cable or any plug head attached thereto.

16. The device of claim 12, wherein said collar mechanisms, said collar ties and said tie connectors are separate, individual members and not a singular molded member.

17. The device of claim 12 wherein said collars may be adjoined on one edge and may snap together and unsnap from each other on the edge opposite said adjoined edge in order to connect to and disconnect from a cord or cable.

18. A method of maintaining a connection between cords and cables, comprising:
a. obtaining a device having a collar mechanism for connecting to said cords and cables, said collar mechanism having a collar tie in connection with said collar mechanism; and
b. connecting said collar tie to a tie connector; said tie connector to facilitate the adjustment of length and tension of said collar tie between said collar mechanism and said tie connector.

19. The method of claim 18, wherein said collar mechanisms, said collar ties and said tie connectors are separate, individual member and not a singular molded member.

20. The method of claim 18, wherein said cord or cable and any associated plug end attached thereto is selected from the group consisting of an indoor plug wire, an outdoor plug wire, an industrial plug, an appliance plug, a telephone plug wire, a LAN plug wire, a WAN plug wire, a cable wire, a data cable, and a coaxial cable.
